(19) United States
(12) Patent Application Publication
(10) Pub. No.: US 2004/0201599 A1
(43) Pub. Date: Oct. 14, 2004

(54) System and method for displaying content without control items

(76) Inventor: Rabindranath Dutta, Austin, TX (US)

Correspondence Address: Kelly K. Kordzik, Suite 800, 100 Congress Avenue, Austin, TX, 78701, US

(21) Appl. No.: 09/726,269

(22) Filed: Nov. 30, 2000

(51) Int. Cl. G06F 3/00

(52) U.S. Cl. 345/700

(57) ABSTRACT

A data processing system is programmed so that a user may select whether control graphical user interface objects are to be displayed along with the content created with an application running on the data processing system. If the user elects not to display such control objects, then the display screen will only display content objects. A user input into a hardware button, or another type of input such as a stylus stroke can result in the return of the display of the control objects to the user.

### TECHNICAL FIELD

The present invention relates in general to data processing systems, and in if particular, to graphical user interfaces.

### BACKGROUND INFORMATION

The graphical user interface (“GUI”) has completely taken over as the preferred method for users to use and interact with their computer devices. This is especially true with respect to desktop and laptop computers, but is also becoming more prevalent in personal digital assistants (“PDA”), web-surfing, cell phones, and other devices. In fact, the web browser GUIs, such as Netscape and Internet Explorer have essentially become the defacto standards for permitting access to the World Wide Web.

With respect to the larger display screen used in desktop and laptop computers, there is plenty of room on this screen to display not only the content of the website visited, but also considerable control GUIs, which enable the user to more efficiently use and manipulate the web browser. Such GUIs are well known, and include the window for entering a URL, the Forward and Back buttons on the browser, etc. Because there is so much more room available on laptop and desktop displays, there has been no motivation to reduce the control items or GUIs in order to provide more area on the display device to show the contents of applications in use. Internet Explorer does provide a Fullscreen feature, which reduces in size many of the control GUIs, but does not completely eliminate them from display to the user.

The problem with the foregoing is with respect to the use of such web browser programs, and other applications, on data processing devices having smaller screens, such as PDAs and cell phones. Without a doubt, display screen real estate is at a premium with these devices, and any means for displaying more content to the user would be advantageous.

### SUMMARY OF THE INVENTION

The present invention addresses the foregoing need by removing all control items from display on a screen so that only the content provided by a particular application is displayed. The result is that all control GUIs, such as menu bars, etc. are hidden from the user's view providing more screen area for the display of content. In order for the user to again display such control GUIs, the user may press a hardware button on the data processing device, or use a choice such as a Ronomatic stroke of a stylus on a touch screen of the display device. This will bring back the control items so that the user can again manipulate the content with such control items.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a prior art PDA;

FIG. 2 illustrates a prior art web browsing cell phone;

FIG. 3 illustrates a PDA configured in accordance with the present invention;

FIG. 4 illustrates a cell phone configured in accordance with the present invention;

FIG. 5 illustrates software components of a program for displaying material on a display screen,

FIG. 6 illustrates a process configured in accordance with the present invention;

FIG. 7 illustrates a screen state changing process configured in accordance with the present invention;

FIG. 8 illustrates a screen rearranger process configured in accordance with the present invention;

FIG. 9 illustrates a screen object; and

FIG. 10 illustrates a data processing system configured in accordance with the present invention.

### DETAILED DESCRIPTION

In the following description, numerous specific details are set forth such as specific program applications, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention will be described below with respect to the use of a web browser application on a PDA or a web browser capable cell phone. However, the present invention should not be limited to such specific applications, but is also applicable to any display device coupled to a data processing system, including desktops and laptops, and to the use of any type of application operable in a data processing system, including, but not limited to, spreadsheet programs, word processing programs, etc.

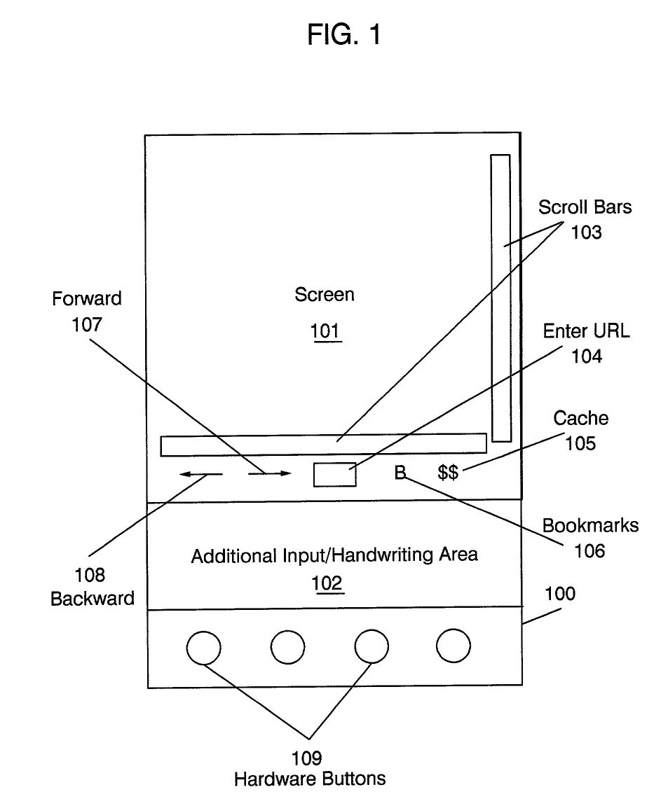

FIG. 1 illustrates a PDA 100 operating an application, such as a web browser program. The web browser application is displayed on display screen 101, and includes many typical control GUIs used within such applications, such as scroll bars 103, a window 104 to enter a URL, bookmark GUIs 106, a cache GUI 105, and Forward 107 and Backward 108 GUIs. Control GUI objects are objects that are typically laid on a screen by layout management software interfaces. The layout managers typically lay out various controls under programmatic directions as coded in a software module. Examples of such objects are buttons, scrollbars, menus that reside in a menubar, the menubar itself and so on. Such layout management software is typically part of programming languages and associated libraries as for example in Java and Microsoft Visual C++. To provide an example, a program while inserting a menu item on a menubar may call a pre-packaged software module with a screen location placement directive, the image of the menu item and the associated text if any. This will insert a menu item with the appropriate image and text in the appropriate location. Furthermore, the programmer may associate various actions that may be performed when the said control item is clicked on with a mouse. Essentially, various events are associated with the interactions with such control GUI objects. Screen 101 also includes an additional input/handwriting area 102 commonly found on such PDAs so that a user may use a stylus within such area 102 to input data with such stylus. PDA 100 also includes one or more hardware buttons 109, which can be programmed to effect predetermined actions within PDA 100.

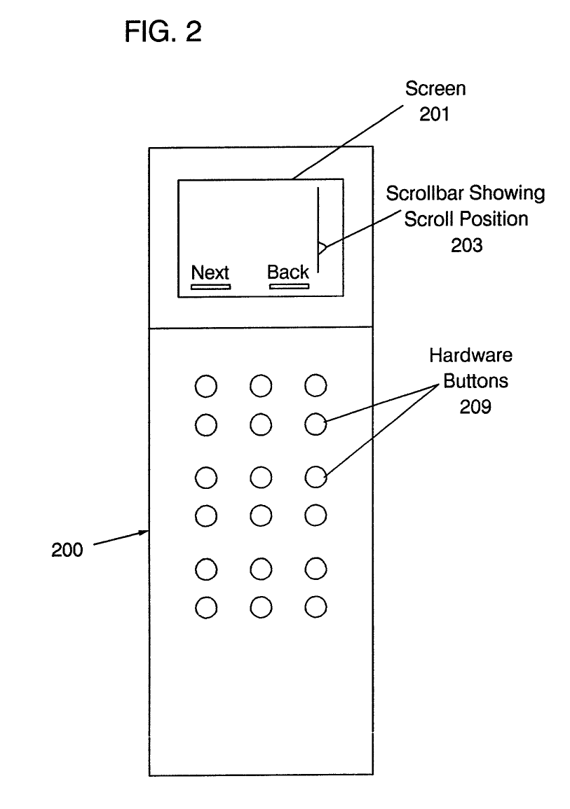

FIG. 2 illustrates a cell phone having a WAP (Wireless Application Protocol) based web browser operating therein. The illustration of FIG. 2 has been simplified, but should clearly indicate that any such cell phone is to be represented. Cell phone 200 would include typical hardware buttons 209, and a display screen 201. In this example, display screen 201 illustrates a web browser application being operated and showing typical control GUIs, such as a scroll bar 203 showing the scroll position, and Next and Back GUIs.

What should be readily apparent is that with such PDAs and cell phones, the display screen provides less area for the inclusion of content because of the display of the various control GUIs, which take up considerable display area on the screen. It is an advantage of the present invention to eliminate such control GUIs from being displayed on such screens so that the screens are available to display content where control items were previously shown.

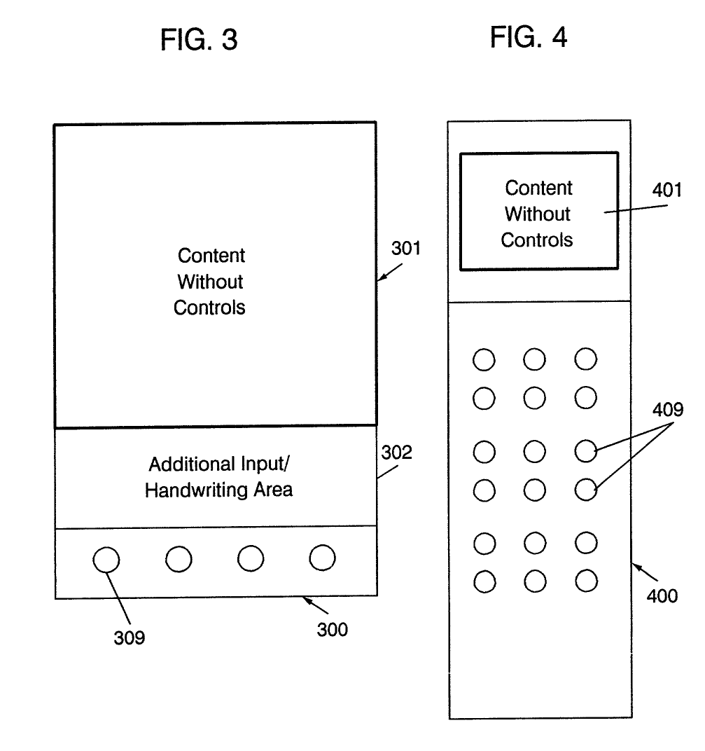

Referring next to FIG. 3, there is illustrated a PDA 300 configured in accordance with the present invention. PDA 300 will include hardware buttons 309, and a display screen 301, which includes an area for displaying content without any control GUIs viewable and the aforementioned input/handwriting area 302.

Likewise, FIG. 4 illustrates a cell phone 400 capable of running such a web browser application, which also includes hardware buttons 409 and display screen 401 illustrating the display of content without any control GUIs viewable. By comparing FIG. 3 to FIG. 1 and FIG. 4 to FIG. 2, it can be readily seen that the display screens have more area for displaying content because of the lack of control GUIs occupying valuable area on the display screens.

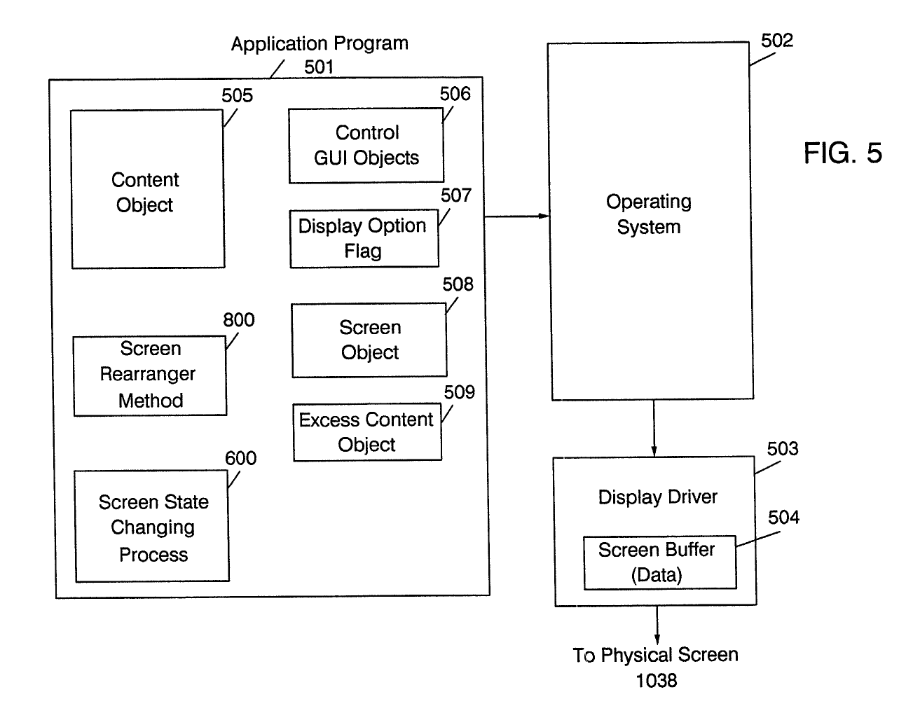

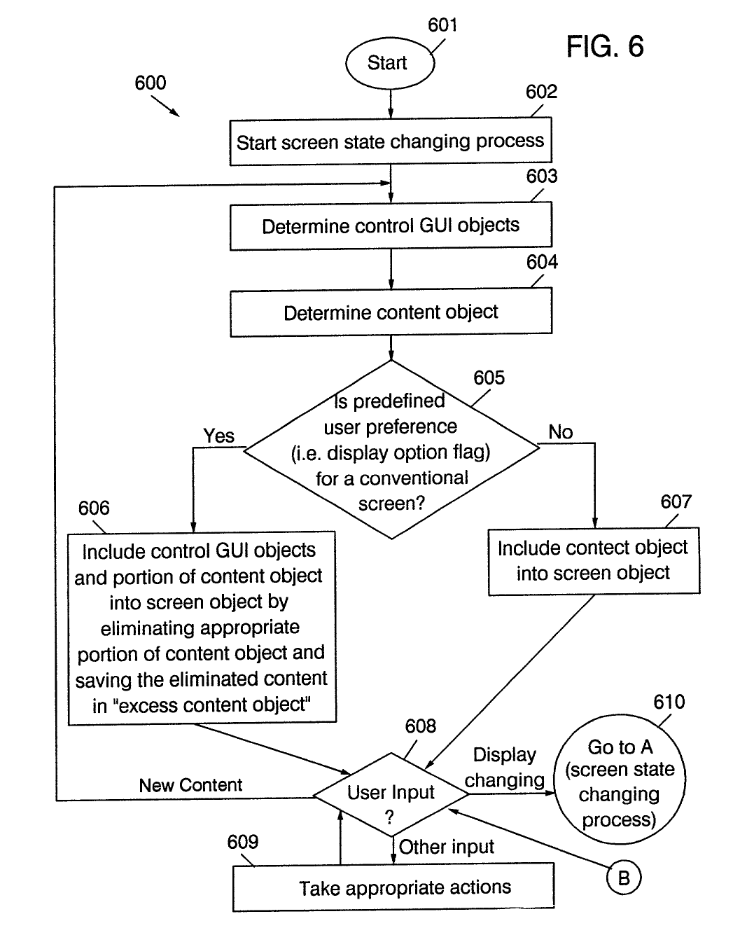

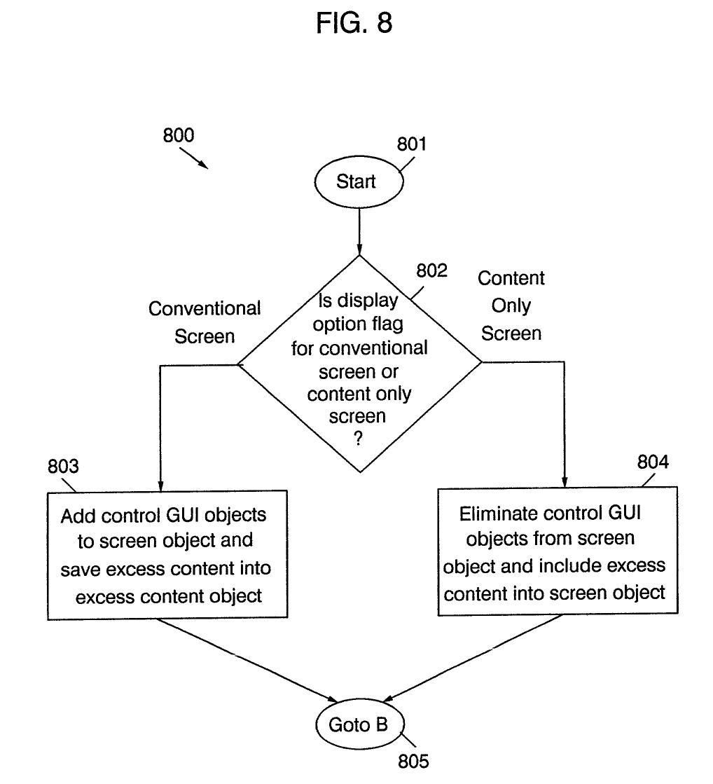

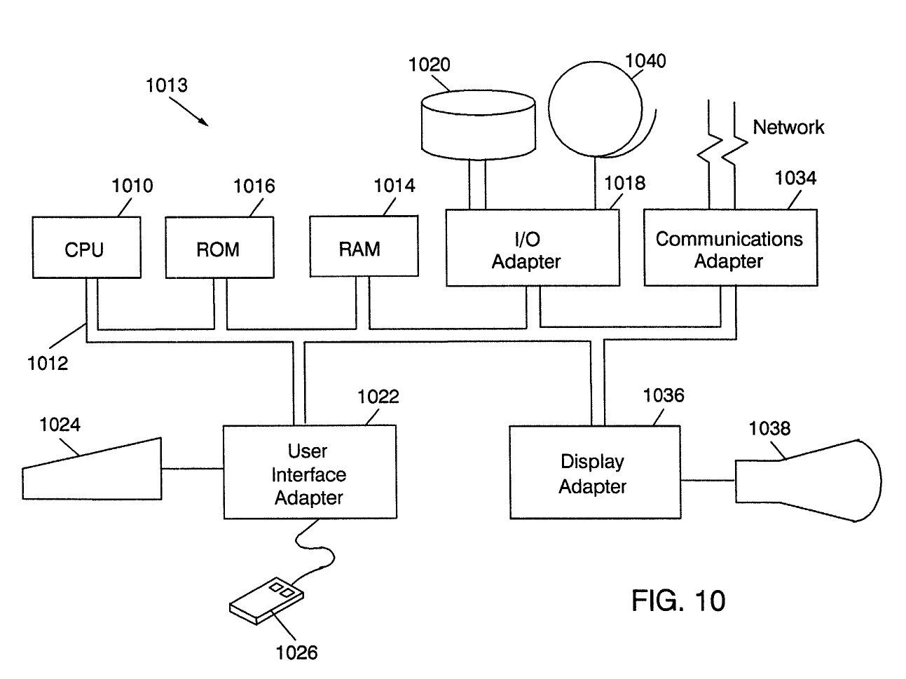

FIG. 5 illustrates software components utilized for displaying information on a display screen such as screens 301 and 401 described above. As is well known, an operating system 502 will interact with an application program 501 to display information on a physical screen 1038 (see FIG. 10) by passing display data received from the application program 501 to the display driver 503, which will include a screen buffer 504. Application program 501 includes a screen rearranger method 800, and a screen changing process 600, both of which will be described in further detail with respect to FIGS. 6 and 8. Application program 501 also includes a content object 505, a screen object 508, an excess content object 509, control GUI objects 506, and a display option flag 507. Each of these software components will be described in more detail below.

Referring to FIG. 6, there is illustrated a flow diagram for operating process 600 of the present invention. Process 600 begins in step 601 and the screen state changing process begins in step 602. In step 603, the application program 501 will determine control GUI objects 506 that are available for display to the user. For example, such control GUI objects 506 may be the various menu and status bars commonly known for use with applications such as word processing programs and web browsers. Such control GUI objects 506 enable the user to open, close, save, and perform other manipulations of content. Such content could, for example, be a document created by a word processing program, a spreadsheet created by a spreadsheet program, or a web page accessed by a web browser.

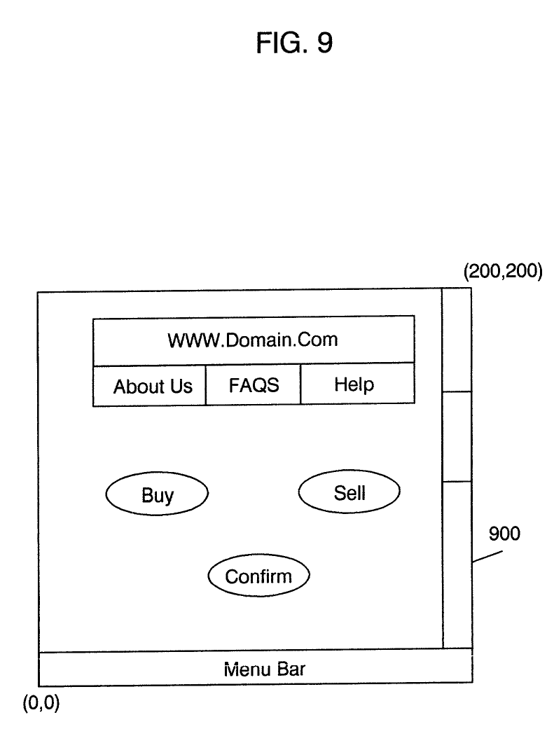

In step 604, this content is maintained by the application program 501 as a content object 505 which is determined and temporarily stored for potential display to the user on the physical display screen 1038. In step 605, a determination is made whether the user has predefined a preference for the display of a conventional screen that includes control GUIs or a screen that will only display content without control GUIs. This predefined user preference will be indicated by a display option flag 507. If the user has set the display option flag to indicate that the user prefers that a conventional display of the content object and the control GUI objects are to be displayed to the user, then the process will proceed to step 606. In step 606, a portion of the content object 505, and the control GUI objects 506 will be combined into the screen object 508 by eliminating an appropriate portion of the content object 505. The portion of the content object 505 that has been eliminated will be taken up by the control GUI objects 506. An example of such a screen object is illustrated in FIG. 9, which shows an example of a portion of the content object 505 that is displayed on the physical screen 1038, along with a menu bar and a scroll bar, comprising in this example the control GUI objects 506 made viewable to the user. This could be accomplished in one of several ways. One manner of displaying such a screen object 508 would be to have the control GUI objects 506 displayed on top of a portion of the control object 505 so that, in a sense, the portion of the content object 505 lies underneath and is hidden from view by the control GUI objects 506. Note that it is well known in the art for application program 501 to know the difference between what are control GUI objects 506, and what is the content object 505, and thus the manipulation of these objects is well known in the art.

In step 605, if the display option flag 506 has not been set previously by the user, then the process will proceed to step 607 to only include the content object 505 into the screen object 508 for display on the physical screen 1038. This is what is essentially illustrated in FIGS. 3 and 4 where there are no control GUI objects 506 displayed.

After steps 606 and 607, the process proceeds to step 608 to determine if there has been any user input. Such input may be a display changing input whereby the process will proceed to step 610, or the input could be new content, whereby the process will return to step 603. Eventually, the new content choice means that the user selected (clicked) on a Superlink in a browser or otherwise inputted something for new content to be displayed. If other input is received, then appropriate actions in response thereto will be performed in step 609.

The screen state changing process 700 will be entered from step 610 into step 702 where the process will wait for a display changing user input. In step 703, the system will wake up on receiving the display changing user input. In step 704, if the user input designates that the user wants a conventional screen with control GUIs, then the process will proceed to step 705 to set the display option flag 507 to “conventional screen.” If the user input indicates that the user does not want a conventional screen, then the process will proceed to step 706 where the display option flag 507 will be set to “content only screen.” Both steps 705 and 706 will proceed to step 707 to call the screen rearranger program 800 described with respect to FIG. 8.

Process 800 begins with step 801 and then proceeds to step 802 to determine whether the display option flag 507 has been set for “conventional screen” or “content only screen.” If the user has set the display option flag to “conventional screen” then the process will proceed to step 803 to add the control GUI objects 506 to the screen object 508, and will save the portion of the content object 505 to be “covered” by the control GUI objects 506 into the excess content object 509. It is the screen object 508 that is then sent to the screen buffer 504.

If in step 802, the user has set the display option flag 507 to “content only screen,” the process will proceed to step 804 to eliminate the control GUI objects 506 from the screen object 508 and instead include the excess content object 509 into the screen object 508 for display on the physical screen 1038. Steps 803 and 804 will proceed to step 805, which returns the present invention to step 608 in process 600.

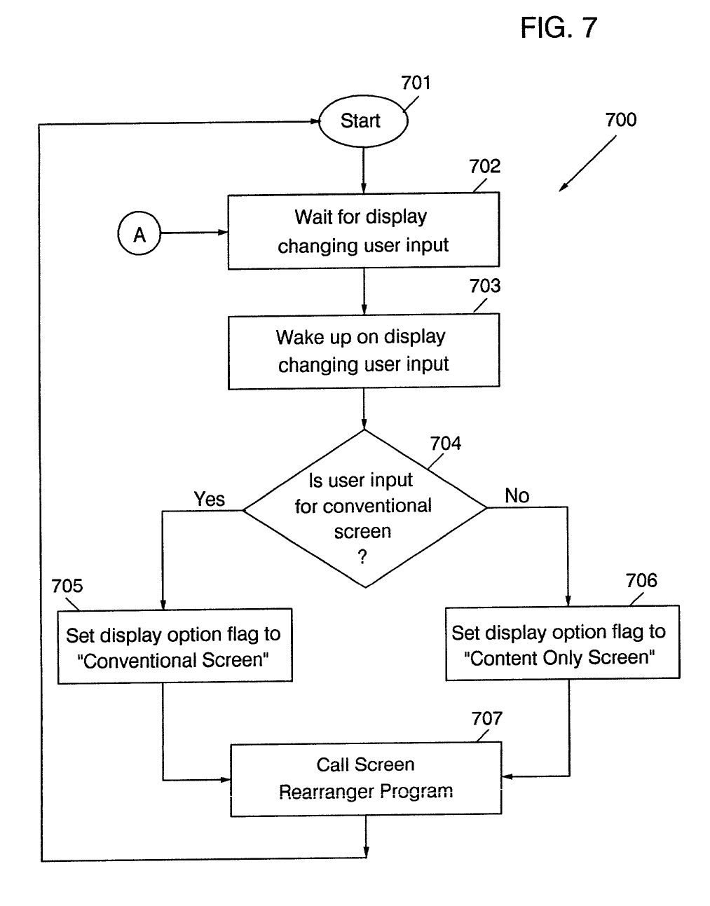

In FIG. 7, there are several ways where a user can determine through the user's input into the data processing system how the user wishes to set the display option flag 507. In one embodiment, one of the hardware buttons, 309, 409 could be programmed so that an activation by the user changes the display option flag 507. For example, referring to FIG. 3, if the PDA 300 has been previously set by the user to display only content on screen 301, then if the user wishes to return the application being run within PDA 300 for display of information to the user in a “conventional screen,” the user may depress one of hardware buttons 309, which will result in program 800 resulting in the control GUI objects 506 being displayed thereafter on display screen 301. Another user input that could be utilized to change the value of the display option flag 507 might be the use of a Ronomatic stroke of a stylus on a portion of the display screen 301 of the PDA device. As an example, a Ronomatic stroke in the form of a circle could be programmed into the PDA 300 to bring back the display of the control GUI objects 506.

Note, the processes in FIGS. 5-7 could all be separate programs or threads or processes within a single program.

The present invention is operable on a data processing system, such as a laptop or desktop computer, a PDA, a PDA watch, or a cell phone as illustrated in FIG. 4. The hardware components of such a data processing system may include one or more of the components illustrated in FIG. 10 showing data processing system 1013.

The system 1000 has a central processing unit (CPU) 1010, which is coupled to various other components by system bus 1012. Read only memory (“ROM”) 1016 is coupled to the system bus 1012 and includes a basic input/output system (“BIOS”) that controls certain basic functions of the data processing system 1000. Random access memory (“RAM”) 1014, I/O adapter 1018, and communications adapter 1034 are also coupled to the system bus 1012. I/O adapter 1018 may be a small computer system interface (“SCSI”) adapter that communicates with a disk storage device 1020. Communications adapter 1034 interconnects bus 1012 with an outside network enabling the data processing system to communicate with other such systems. Input/Output devices are also connected to system bus 1012 via user interface adapter 1022 and display adapter 1036. Keyboard 1024 and mouse 1026 are all interconnected to bus 1012 via user interface adapter 1022. Display monitor 1038 is connected to system bus 1012 by display adapter 1036. In this manner, a user is capable of inputting to the system throughout the keyboard 1024, mouse 1026 or a stylus on a touch screen and receiving output from the system via display 1038.

Preferred implementations of the invention include implementations as a computer system programmed to execute the method or methods described herein, and as a computer program product. According to the computer system implementation, sets of instructions for executing the method or methods are resident in the random access memory 1014 of one or more computer systems configured generally as described above. Until required by the computer system, the set of instructions may be stored as a computer program product in another computer memory, for example, in disk drive 1020 (which may include a removable memory such as an optical disk or floppy disk for eventual use in the disk drive 1020). Further, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed is:

1. A method for displaying information on a data processing system, comprising the steps of:
creating a content object;
creating control GUI objects;
determining if an input has been received to display the content object without displaying the control GUI objects; and
displaying the content object without displaying the control GUI objects if the input has been received.

2. The method as recited in claim 1, further comprising the step of displaying the content object and the control GUI objects if an input has been received to display the content object with the control GUI objects.

3. The method as recited in claim 1, wherein the content object and the control GUI objects are created by an application program running in the data processing system, and wherein the content object contains no control GUI objects.

4. In a data processing system, a method comprising the steps of:
in an application program, determining control GUI objects and a content object;
determining if a user has set a display option flag indicating a preference for either a conventional screen object to be displayed comprising a display of the control GUI objects and the content object or an unconventional screen object to be displayed comprising a display of the content object but not any of the control GUI objects; and
determining the screen object to include the content object but not any of the control GUI objects as a function of the display option flag having a setting indicating a user preference for display of the content object without any of the control GUI objects.

5. The method as recited in claim 4, further comprising the step of displaying the screen object on a display device of the data processing system.

6. The method as recited in claim 5, further comprising the steps of:
receiving input from the user to set the display option flag indicating the preference for the conventional screen object to be displayed comprising the display of the control GUI objects and the content object;
determining the screen object to include the content object and the control GUI objects as a function of the display option flag having a setting indicating the user preference for display of the content object with the control GUI objects; and
displaying the screen object on the display device of the data processing system.

7. The method as recited in claim 6, wherein if the display option flag is set to indicate a preference for the conventional screen object then the control GUI objects are added to the screen object and excess content to be covered by the control GUI objects is saved in an excess content object.

8. The method as recited in claim 7, wherein if the display option flag is set to indicate a preference for the unconventional screen object then the control GUI objects are eliminated from the screen object and the excess content object is included in the screen object.

9. A computer program product adaptable for storage on a computer readable means, wherein the computer program product comprises an application program that comprises the program steps of:
determining control GUI objects and a content object;
determining if a display option flag has been set indicating a preference for either a conventional screen object to be displayed comprising a display of the control GUI objects and the content object or an unconventional screen object to be displayed comprising a display of the content object but not any of the control GUI objects; and
determining the screen object to include the content object but not any of the control GUI objects as a function of the display option flag having a setting indicating a preference for display of the content object without any of the control GUI objects.

10. The computer program product as recited in claim 9, further comprising the program steps of:
determining that the display option flag has been reset to indicate the preference for the conventional screen object to be displayed comprising the display of the control GUI objects and the content object; and
determining the screen object to include the content object and the control GUI objects as a function of the reset display option flag having a setting indicating the preference for display of the content object with the control GUI objects.

11. The computer program product as recited in claim 10, wherein if the display option flag is set to indicate the preference for the conventional screen object then the control GUI objects are added to the screen object and excess content to be covered by the control GUI objects is saved in an excess content object.

12. The computer program product as recited in claim 11, wherein if the display option flag is set to indicate the preference for the unconventional screen object then the control GUI objects are eliminated from the screen object and the excess content object is included in the screen object.

13. A data processing system comprising:
a processor;
a display coupled to the processor;
a memory storing an application program further comprising:
a screen object that is then displayed on the display;
a content object;
a control GUI object;
a display option flag; and
a screen state changing program for determining whether the screen object will include only the content object without any control GUI object as a function of the display option flag.

14. The system as recited in claim 13, wherein the screen state changing program will determine the screen object to include only the content object without any control GUI object when the display option flag has been determined to be set for a preference that an unconventional screen be displayed whereby the content is displayed and no control GUIs are displayed on the display.

15. The system as recited in claim 14, wherein the display option flag is settable by input from a user of the data processing system.

16. The system as recited in claim 15, wherein when the display option flag is reset for a preference that a conventional screen be displayed on the display whereby the content and the control GUIs are displayed, then the screen state changing program will determine that the screen object will include the content object and the control GUI object, any of the control object displaced by the control GUI object will be stored into an excess content object.

17. The system as recited in claim 16, wherein the display option flag is reset for the preference that the conventional screen be displayed by receipt of a user selection of a hardware button on the system.

18. The system as recited in claim 16, wherein the display option flag is reset for the preference that the conventional screen be displayed by receipt of a Ronomatic action on the display by a user with a stylus.

19. The system as recited in claim 14, wherein the data processing system is a PDA.

20. The system as recited in claim 14, wherein the data processing system is a laptop computer.

21. The system as recited in claim 14, wherein the data processing system is a desktop computer.

22. The system as recited in claim 14, wherein the data processing system is a wireless communications device.
